(19) United States
(12) Patent Application Publication
(10) Pub. No.: US 2022/0287502 A1
(43) Pub. Date: Sep. 15, 2022

(54) AIR FRYER WITH COOLING FUNCTION

(71) Applicant: GUANGDONG YOULONG ELECTRICAL APPLIANCES CO.,LTD, Zhongshan (CN)

(72) Inventor: Yu LIU, Zhongshan (CN)

(21) Appl. No.: 17/367,594

(22) Filed: Jul. 5, 2021

(30) Foreign Application Priority Data
Mar. 9, 2021 (CN) 202110255588.5
Mar. 9, 2021 (CN) 202120498326.7

(51) Int. Cl. A47J 37/06

(52) U.S. Cl. CPC A47J 37/0641; A47J 37/0664

(57) ABSTRACT

The disclosure discloses an air fryer with cooling function. By setting the first air suction structure on the bottom wall of the bottom cover, an air supply duct is set on the side wall of the bottom cover, and an air guide cover is added on the middle shell. When the exhaust fan is started, the external air flows in from the first air suction structure, enters the air guide area through the air supply duct, and then enters the exhaust area, and finally is discharged from the exhaust area to the outside. As the outside air continuously flows along the side wall of the bottom cover, the heat radiated from the side wall of the heating cavity can be taken away during heating. The side wall of the bottom cover is in the normal temperature state. Similarly, the bottom wall of the bottom cover can take away a large amount of heat when the air continuously flows in, and the bottom wall is in the normal temperature state. Due to the barrier effect of the air guide cover, the upper cover can avoid a large amount of heat radiated from the heating cavity, and by setting a second air suction structure, the outside air can continuously flow into the electric appliance holding cavity to take away a small part of the heat radiated from the heating cavity to the electric appliance holding cavity, the upper cover is in the normal temperature state, and the outer wall of the air fryer is in the normal temperature state.

### TECHNICAL FIELD

The present disclosure relates to the technical field of kitchenware manufacturing, in particular to an air fryer with cooling function.

### BACKGROIJND

Air fryer is a kind of machine that can use air to “cook”. It, mainly uses air to replace the hot oil in the frying pan and make the food cooked. At the same time, the hot air also blows away the water on the surface of the food, which makes the food achieve the effect of frying. Because the air fryer can greatly reduce the oil on the surface of food, which is conducive to human health, it is more and more popular by users. But at present, the wind force in the internal air duct of the air fryer is not concentrated, which leads to the overall high temperature in the inner cavity of the fryer and the poor heat dissipation effect of the whole machine. When cooking food, the temperature of the shell of the fryer is easy to increase, and the user is easy to be scalded by mistake. Moreover, due to the poor heat dissipation effect of the whole machine, the long-term use of the fryer will greatly damage the internal electrical components and shorten the service life of the whole machine.

### SUMMARY

### Object of the Present Disclosure

In order to overcome the above shortcomings, the present disclosure aims to provide an air fryer with cooling function, so as to solve the technical problems of poor heat dissipation effect of the shell of the existing air fryer which causes of heating of the shell and easy scalding of users and affecting the service life of the whole machine.

### Technical Solution

In order to achieve the above object, the technical solution provided by the disclosure is as follows:

An air fryer with cooling function, including an upper cover, a middle shell and a bottom cover which are connected with each other from top to bottom. The middle shell is provided with a heating cavity, and an air supply duct is formed between the heating cavity and an inner wall of the middle shell. The top wall of the heating cavity is successively covered with a motor cover and an air guide cover. An exhaust area I communicated with the outside is formed between the motor cover and the top wall of the heating cavity, an exhaust fan is arranged in the exhaust, area I. The air guide area H communicated with the exhaust area I is formed between the air guide cover and the top wall of the motor cover, the air guide area II is communicated with the air supply duct, a bottom wall of the bottom cover is provided with a plurality of first air suction structures, and the first air suction structures are communicated with the air supply duct.

The top wall of the upper cover is provided with a second air suction structure, and an electrical installation area III communicating the air guide area II is formed between the top wall of the upper cover and the motor cover, the external air is entered into the electrical installation area III from the second air suction structure driven by the exhaust fan, and is entered into the air guide area II from the electrical installation area III, and finally is discharged from the exhaust area Ito the outside.

In the present disclosure, by setting the first air suction structure on the bottom wall of the bottom cover, an air supply duct is set on the middle shell, and an air guide cover is added on the middle shell. When the exhaust fan is started, the external air flows in from the first air suction structure, enters the air guide area II through the air supply duct on the side wall of the bottom cover, and then enters the exhaust area I from the air guide area II, and finally is discharged from the exhaust area I to the outside. As the outside air continuously flows along the side wall of the bottom cover, the heat radiated from the side wall of the heating cavity can be taken away during heating, so that the side wall of the middle shell is in the normal temperature state. Similarly, the bottom cover can take away a large amount of heat when the air continuously flows in, and the bottom wall is in the normal temperature state. Due to the barrier effect of the air guide cover, the upper cover can avoid a large amount of heat radiated from the heating cavity to the upper cover, so as to lower the temperature. And by setting a second air suction structure, the outside air can continuously flow into the electric appliance holding cavity to take away a small part of the heat radiated from the heating cavity to the electric appliance holding cavity, so as to ensure that the upper cover is in the normal temperature state. Therefore, the outer wall of the whole air fryer is in the normal temperature state, which can avoid scalding the user. Furthermore, the air entering into the electric appliance holding cavity can also take away the heat generated by the electrical parts installed in the electric appliance installation area when working, which can protect the electrical components and prolong the service life of the fryer.

In some embodiment, two independent heating cavities are arranged in the middle shell, and a baffle plate is vertically arranged between the two heating cavities on the air guide cover to divide the air guide area II of the two heating cavities. Because the air guide areas of the two heating cavities are set separately, the different heating temperatures of the two fryers can avoid the different air temperatures flowing into the air guide areas, which will cause the mutual disturbance of the air and the lack of directionality, leading the air cannot effectively enter the exhaust area and affecting the heat dissipation effect.

In some embodiment, the air fryer further includes a door body, and a ventilation interlayer communicating the first suction structure and the air guide area II is formed in the door body. By setting the ventilation interlayer on the door body, the air flow can take away the temperature on the door body, so as to avoid the high temperature of the door, body to scald the user.

In some embodiment, the air guide cover corresponds to one side of the motor cover forms a conical air guide inclined surface protruding to one side of the motor cover. The air guide inclined surface protrudes and extends to one side of the motor cover. By setting the air guide inclined surface, the air can be accurately and quickly led into the exhaust area for discharging, and the heat dissipation efficiency is improved.

In some embodiment, the interval between the air guide cover and the motor cover is lcm to 10cm. By optimizing the interval between the air guide cover and the motor cover, the air guide cover and the motor cover can form a larger wind pressure, and the air can be quickly introduced into the exhaust area under a larger pressure, so as to improve the heat dissipation efficiency.

In some embodiment, the side wall of the upper cover is provided with an air outlet. Part of the air entering the electrical installation area can be directly discharged from the air outlet, so as to prevent the low-temperature air in the electrical installation area from entering into the air guide area due to the different air temperature between the electrical installation area and the air guide area, and the high-temperature air in the air guide area and the low-temperature air in the electrical installation area will disturb each other, which will affect the direction of the air in the air guide area and prevent the air from entering into the exhaust area effectively and accurately, so as to affect the heat dissipation efficiency.

In some embodiment, the exhaust area is internally communicated with the heating cavity. Because the exhaust area is communicated with the interior of the heating cavity, part of the hot air entering the exhaust area is discharged to the outside and part of the hot air can enter the heating cavity to form convection with the air in the heating cavity, which promotes the air in the heating chamber to flow quickly and cook the food.

In some embodiment, the first air suction structure and the second air suction structure are air suction holes or air suction grooves.

### BRIEF DESCRIPTION OF THE DRAWINGS

FIG. 1 is a structural sectional view of an air fryer with cooling function of the present disclosure;

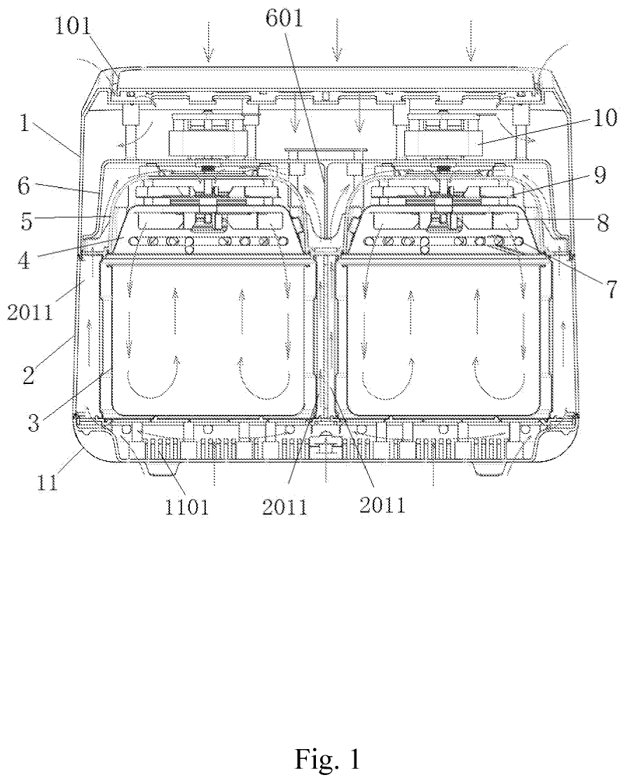

FIG. 2 is a distribution diagram of each area of the air fryer with cooling function of the present disclosure;

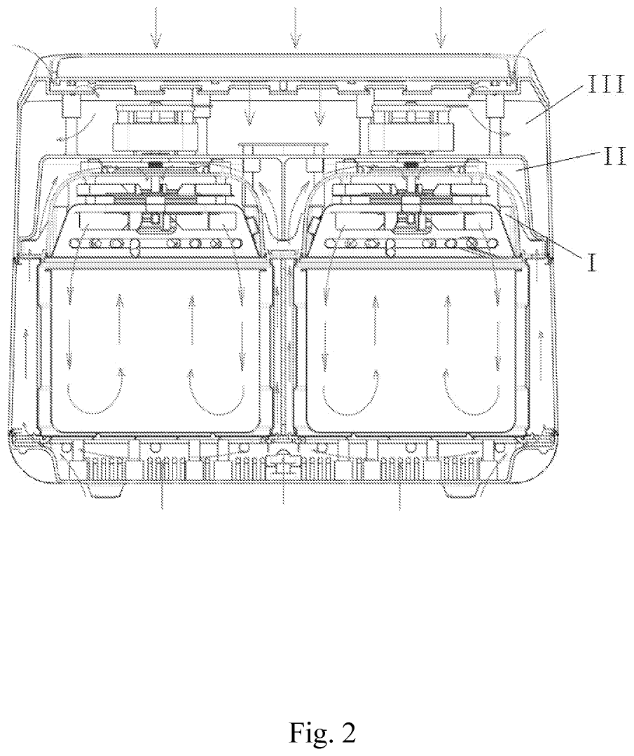

FIG. 3 is an exploded view of the air fryer with cooling function of the present disclosure.

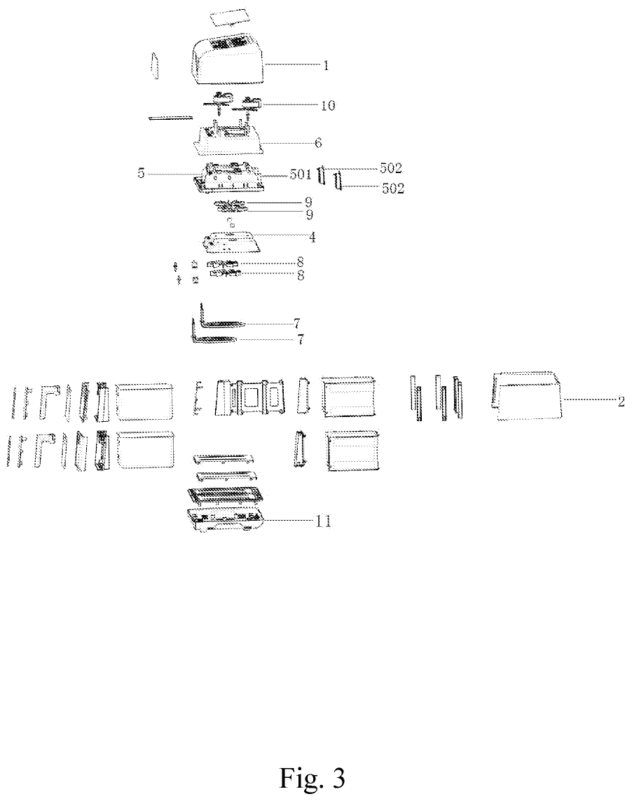

### REFERENCE MARK

1. upper cover; 101. second air suction structure; 2. middle shell; 2011, air supply duct; 3. heating cavity; 4, electric heating tube cover 5. motor cover; 501. exhaust duct; 502. exhaust port; 6. air guide cover; 601, baffle plate; 7. electric heating tube; 8. heating fan; 9. exhaust fan; 10. motor; 11. bottom cover; 1101. first air suction structure.

### DETAILED DESCRIPTION OF THE EMBODIMENTS

In order to make the object, technical solution and advantages of the present disclosure more clear, the present disclosure is further described in detail in combination with the specific embodiment and with reference to the drawings. It should be understood that these descriptions are only illustrative and are not intended to limit the scope of the present disclosure. In addition, in the following description, the description of well-known structures and techniques is omitted to avoid unnecessary confusion of the concepts of the present disclosure.

The present disclosure is provided an air fryer with cooling function, which includes an upper cover 1 a middle shell 2 and a bottom cover 11 which are connected with each other from top to bottom. The middle shell 2 is internally provided with a heating cavity 3, and an air supply duct 2011 is formed between the heating cavity 3 and an inner wall of the middle shell 2. The top wall of the heating cavity 3 is successively covered with a motor cover 5 and an air guide cover 6, an exhaust area I communicated with the outside is formed between the motor cover 5 and the top wall of the heating cavity 3. An exhaust fan 9 is arranged in the exhaust area I, an air guide area II communicated with the exhaust area I is formed between the air guide cover 6 and the top wall of the motor cover 5. The air guide area II is communicated with the air supply duct 2011, a bottom wall of the bottom cover 11 is provided with a plurality of first air suction structures 1101, and the first air suction structures 1101 are communicated with the air supply duct 2011.

The top wall of the upper cover 1 is provided with a second air suction structure 101, and an electrical installation area III communicating the air guide area II is formed between the top wall of the upper cover 1 and the motor cover 5. The external air is entered into the electrical installation area III from the second air suction structure 101 driven by the exhaust fan 9, and is entered into the air guide area II from the electrical installation area III, and finally is discharged from the exhaust area Ito the outside.

In the present disclosure, by setting the first air suction structure 1101 on the bottom wall of the bottom cover 11, an air supply duct 2011 is set on the middle shell 2, and an air guide cover 6 is added on the middle shell 2. When the exhaust fan 9 is started, the external air flows in from the first air suction structure 1101 under the pressure difference, enters the air guide area II through the air supply duct 2011 on the side wall of the bottom cover 11, and then enters the exhaust area I from the air guide area II, and finally is discharged from the exhaust area I to the outside. As the outside air continuously flows along the side wall of the air supply duct 2011, the heat radiated from the side wall of the heating cavity 3 can be taken away during heating, so that the side wall of the middle shell 2 is in the normal temperature state. Similarly, the bottom cover 11 can take away a large amount of heat when the air continuously flows in, and the bottom wall is in the normal temperature state. Due to the barrier effect of the air guide cover 6, the upper cover 1 can avoid a large amount of heat radiated from the heating cavity 3 to the upper cover 1, so as to lower the temperature. And by setting a second air suction structure 101, the outside air can continuously flow into the electric appliance holding cavity to take away a small part of the heat radiated from the heating cavity 3 to the electric appliance holding cavity, so as to ensure that the upper cover 1 is in the normal temperature state. Therefore, the outer wall of the whole air fryer is in the normal temperature state, which can avoid scalding the user. Furthermore, the air entering into the electric appliance holding cavity can also take away the heat generated by the electrical parts installed in the electric appliance installation area when working, which can protect the electrical components and prolong the service life of the fryer.

Specifically, the first and second air suction structures 101 can be air suction holes or air suction grooves. In the present disclosure, the first air suction structure 1101 is set as air suction holes, and the second air suction structure 101 is set as air suction grooves. The structures of the first and second air suction structures 101 can be set according to the actual production needs. The present disclosure is not limited, and the air suction holes can be arranged into a strip structure or randomly distributed.

Specifically, the heating cavity 3 is provided with a metal inner tank for holding food, the top of which is an electric heating tube cover 4, the electric heating tube 7 and -a heating fan 8 are arranged under the electric heating tube cover 4, and the heating fan 8 is rotated to drive the hot air around the electric heating tube 7 to circulate in the heating, cavity 3 for frying food.

Specifically, an exhaust duct 501 is arranged on the side wall of the motor cover 5, the exhaust duct 501 is butted with the exhaust port 502 arranged on the middle shell 2 or the upper cover 1, and the hot air is discharged from the exhaust port 502 to the outside through the exhaust duct 501.

Specifically, the motor 10 is installed on the top of the air guide cover 6, which is located in the electrical installation area III, extends into the exhaust area I and the heating cavity 3 through a drive shaft, and is driven and connected with the exhaust fan 9 and the heating fan 8. The electrical installation area III is also provided with a circuit board to control the operation of the motor 10 and the heater.

Preferably, through holes are set at the top of the air guide cover 6, the motor cover 5 and the electric heating tube cover 4. The air guide area II is communicated with the exhaust area I and the heating cavity 3 through the through holes. Since the exhaust area I is communicated with the heating cavity 3, part of the hot air flowing into the exhaust area I is discharged through the exhaust duct 501. In addition, part of the hot air enters into the heating, cavity 3 and forms convection with the hot air in the heating cavity 3, which accelerates the air flow in the heating cavity 3.

Specifically, the air supply duct 2011 set on the inner wall of the middle shell 2 is a plurality of tubular structures with intervals, and the outside air will flow regularly to the air guide area II along the air supply duct 2011, which can improve the direction of air flow, improve the speed of air flow, and improve the heat dissipation effect. Moreover, the air supply duct 2011 set on the side wall of the middle shell 2 can also play the role of reinforcing ribs, so as to avoid that the inner part of the middle shell 2 with poor structural strength and easy to he damaged.

Preferably, the disclosure is provided with two fryers, which can realize multi food frying at the same time and improve the frying efficiency. Specifically, the middle shell 2 is provided with two mounting positions, the middle of the two mounting positions is separated by a side wall, and the side wall is also provided with an air supply duct in the middle. Preferably, in order to improve the direction of air flow, a baffle plate 601 is vertically provided on the air guide cover 6, and the baffle plate 601 is against the middle side wall of the middle shell 2. The baffle plate 601 divides the air guide area II of the two heating cavities, so as to form two independent air guide areas II, so as to avoid the mutual disturbance of different air temperatures flowing into the air guide area II due to different heating temperatures of the two fryers, which will cause the air flow to lose its direction and, affect the heat dissipation effect.

Alternatively, three or more fryers can be provided, and a corresponding number of the baffle plate 601 can be provided. The disclosure does not limit the number of fryers.

Specifically, the fryer also includes a door body, and a ventilation interlayer is formed by two opposite glass in the door body. The two ends of the ventilation interlayer are opened and respectively communicated with the first air suction structure 1101 of the bottom cover 11 and the air guide area II, when the exhaust fan 9 is started, the air enters into the ventilation interlayer from the first air suction structure 1101 to take away the heat radiated by the heating cavity 3 to the door body, then it enters the an guide area II and finally discharges from the exhaust duct 501 of the exhaust area I.

Preferably, the air guide cover 6 corresponds to one side of the motor cover forms a conical air guide inclined surface protruding to one side of the motor cover. The air guide inclined surface protrudes and extends to one side of the motor cover. By setting the air guide inclined surface when the air enters the air guide area II, it can be directly led into the exhaust area along the arc surface of the air guide inclined surface, so as to improve the direction of air flow and the air guide effect.

Preferably, the side wall of the upper cover 1 can, also be provided with an air outlet, part of the air entering the electric appliance holding cavity III can be directly discharged from the air outlet, only a small amount of air enters into the air guide area II, so as to avoid that most of the low-temperature air in the electric appliance holding cavity III enters into the air guide area II and interferes with the high-temperature air in the air guide area II, affecting the regularity of air flow and heat dissipation effect.

Preferably, the interval between the air guide cover 6 and the motor cover 5 is lcm to 10cm. In this way, the air guide cover 6 can form a larger wind pressure, which can promote the air flowing into the air guide area II to quickly flow into the exhaust area I under high pressure, so as to improve the heat dissipation effect. If the interval between the air guide cover 6 and the motor cover 5 is too large, and the wind pressure is low, the air is difficult to quickly enter the exhaust area I under low pressure, which affects the heat dissipation effect.

It should be understood that the above specific embodiments of the present disclosure are only used to illustrate or explain the principles of the present disclosure by exemplary description, and do not constitute a limitation of the present disclosure. Therefore, without deviating from the spirit and scope of the present disclosure, any modification, equivalent replacement, improvement, etc shall be included. in the scope of the present disclosure. Furthermore, the appended claims of the present disclosure are intended to cover all variations and modifications that fall within the scope and boundaries of the appended claims, or equivalent forms of such scope and boundaries.

1. An air fryer with cooling function, comprising an upper cover (1), a middle shell (2) and a bottom cover (11) which are connected with each other from top to bottom, the middle shell (2) is provided with a heating cavity (3), and an air supply duct (2011) is formed between the heating cavity (3) and an inner wall of the middle shell (2); a top wall of the heating cavity (3) is successively covered with a motor cover (5) and an air guide cover (6), an exhaust area I communicated with the outside is formed between the motor cover (5) and the top wall of the heating cavity (3), an exhaust fan (9) is arranged in the exhaust area I, an air guide area II communicated with the exhaust area I is formed between the air guide cover (6) and the top wall of the motor cover (5), the air guide area II is communicated with the air supply duct (2011), a bottom wall of the bottom, cover (11) is provided with a plurality of first air suction structures (1101), and the first air suction structures (1101) are communicated with the air supply duct (2011); external air is entered from the first air suction structure (1101) into the air guide area II through the air supply duct (2011) driven by the exhaust fan (9), and is led into the exhaust area I through the air guide area II, and finally is discharged from the exhaust area Ito the outside;
an top wall of the upper cover (1) is provided with a second air suction structure (101), and an electrical installation area III communicating the air guide area II is formed between the top wall of the upper cover (1) and the motor cover (5), the external air is entered into the electrical installation area III from the second air suction structure (101) driven by the exhaust fan (9), and is entered into the air guide area II from the electrical installation area III, and finally is discharged from the exhaust area Ito the outside.

2. The air fryer with cooling function according to claim 1, wherein two independent heating cavities (3) are arranged in the middle shell (2), and a baffle plate (601) is vertically arranged between the two heating cavities (3) on the air guide cover (6) to divide the air guide area II of the two heating cavities (3).

3. The air fryer with cooling function according to claim 1, wherein the air fryer further comprises a door body, and a ventilation interlayer communicating the first suction structure (1101) and the air guide area II is formed in the door body.

4. The air fryer with cooling function according to claim 1, wherein the air guide cover (6) corresponds to one side of the motor cover (5) forms a conical air guide inclined surface protruding to one side of the motor cover (5).

5. The air fryer with cooling function according to claim 4, wherein an interval between the air guide cover (6) and the motor cover (5) is lcm to 10cm.

6. The air fryer with cooling function according to claim 1, wherein a side wall of the upper cover (1) is provided with an air outlet.

7. The air fryer with cooling function according to claim 1, wherein the exhaust area I is internally communicated with the heating cavity (3).

8. The air fryer with cooling function according to claim 1, wherein the first air suction structure and the second air suction structure are air suction holes or air suction grooves.
